(19) United States
(12) Patent Application Publication
(10) Pub. No.: US 2004/0121053 A1
(43) Pub. Date: Jun. 24, 2004

(54) Food product with anti-browning agent and method of making the same

(76) Inventor: Amr Shaheed, Howell, NJ (US)

Correspondence Address: Kevin E. McVeigh, Esq., RHODIA INC., 259 Prospect Plains Road, Cranbury, NJ, 08512, US

(21) Appl. No.: 10/328,283

(22) Filed: Dec. 23, 2002

(51) Int. Cl. A23L 1/27

(52) U.S. Cl. 426/268

(57) ABSTRACT

A pulp or mashed fruit or vegetable food product containing at least one sulfated polysaccharide to inhibit enzymatic browning and method of preparing the same.

### FIELD OF THE INVENTION

The present invention is generally directed to a pulp or mashed food product which contains an anti-browning agent in an amount sufficient to prevent enzymatic browning of the pulped or mashed food product.

### BACKGROUND OF THE INVENTION

Fruits and vegetables undergo browning when subjected to mechanical injury. Enzymatic browning results from the polyphenol oxidaze-catalyzed oxidation of phenolic compounds to O-quinones, which polymerize to form dark-colored pigments. Discolored fruits and vegetables of this type present a problem to the industry because of their undesirable appearance and the perception that the food product is inedible. Furthermore, such products may become less tasteful presenting a further reason for consumer avoidance of such products.

Efforts have been made to inhibit the enzymatic browning of mechanically injured raw fruits and vegetables by treating the same which ascorbic acid-2-phosphate esters and ascorbyl-6-fatty acid esters individually or in combination as disclosed in Gerald M. Sapers (U.S. Pat. No. 4,814,192).

Prepared foods including fruits and vegetables such as those used in salad bars and prepared salads sold in fast food restaurants have been treated with a combination of ascorbic acid and thixotropic gum such as xanthan gum such as disclosed in Clement R. Wyss et al. (U.S. Pat. No. 4,959,230).

A further process for inhibiting enzymatic browning in raw fruit and vegetables comprises treating the juices with cyclodextrins which may include both soluble and insoluble cyclodextrins as disclosed in Kevin B. Hicks et al. (U.S. Pat. No. 4,975,293).

A specific method of treating raw fruit juice and/or raw vegetable juice is disclosed in Cindy B. S. Tong et al. (U.S. Pat. No. 6,020,018). The fruit juices are treated with at least one sulfated polysaccharide in an amount sufficient to prevent enzymatic browning. The presence of an organic acid such as citric acid is required for the treatment of juices at relatively low levels of the sulfated polysaccharide.

It would be an advance in the art of food preservation to provide a method of preserving a pulp or mashed fruit or vegetable so that the food product is resistant to enzymatic browning. It would be a further advance in the art to provide a pulp or mashed food product which may employ reduced amounts of an anti-browning agent yet exhibits significant resistance to enzymatic browning.

### SUMMARY OF THE INVENTION

The present invention is generally directed to a pulp or mashed food product and method of inhibiting enzymatic browning of the food product through the use of at least one sulfated polysaccharide. The inhibition of enzymatic browning may be achieved in the absence of an organic acid or other acidulant which has been used in the past to lower the pH of the food product.

In accordance with a specific aspect of the present invention, there is provided a method of inhibiting enzymatic browning of pulp or mashed fruits and vegetables comprising combining a pulp or mashed form of the fruit or vegetable with at least one sulfated polysaccharide in an amount sufficient to inhibit enzymatic browning. Food products obtained by the present method are also encompassed by the present invention.

### DETAILED DESCRIPTION OF THE INVENTION

The present invention is directed to the production of a food product made from pulped or mashed fruits and/or vegetables in which a particular class of agents are added to inhibit enzymatic browning. The pulp or mashed food product is generally obtained by taking the fruit and/or vegetable and using an appropriate device to form a mashed product or a pulp product. Such devices are well known in the art and include meat grinders and other type of grinders as well as blenders, and the like.

The mashed or pulped product is then combined with an effective amount of a sulfated polysaccharide and then optionally subjected to mixing or mechanical agitation with or without the presence of water. When water is employed, the water and sulfated polysaccharide are combined and mixed until a uniform mixture is obtained.

It has been observed in accordance with the present invention that relatively small amounts of the sulfated polysaccharide are effective in achieving the desired inhibition of enzymatic browning. This effect is achieved in the absence of an organic acid or other acidulant which has heretofore been used to lower the pH as provided in U.S. Pat. No. 6,020,018.

The sulfated polysaccharide is provided in an amount effective to inhibit enzymatic browning. The amount of the sulfated polysaccharide may range from 0.05 to 0.3% by weight based on the total weight of the pulp or mashed fruit and/or vegetable. It has been observed that desirable results have been achieved using relatively low amounts of the sulfated polysaccharide typically less than about 0.25% by weight and even at less than 0.20% by weight.

The sulfated polysaccharide is any sulfated polysaccharide that can achieve the desirable inhibition of enzymatic browning. Preferred sulfated polysaccharides include carrageenans, amylose sulfate, xylan sulfate and combinations thereof. The preferred carrageenans are those selected from lambda carrageenan, iota carrageenan, kappa carrageenan and combinations thereof. A particularly preferred sulfated polysaccharide includes at least one carrageenan selected from iota carrageenan and lambda carrageenan.

As previously indicated, water may be added to the mashed or pulp food product by combining water with the dry sulfated polysaccharide. The amount of water will typically be only that amount necessary to form a uniform aqueous mixture having the sulfated polysaccharide dispersed therein. Typically the amount of water employed with the sulfated polysaccharide will be in the range of from 0.5 to 1.5% by weight, typically about 1.0% by weight based on the total weight of the food product.

The fruits and vegetables that may be employed to prepare a food product in accordance with the present invention can be any fruits or vegetable. Typical fruits will include avocado, peach, pear, apple, plum and the like and combinations thereof. Typical vegetables will include green vegetables such as green beans, broccoli, peas, and the like in combinations thereof. Non-green vegetables will includes yellow and red peppers, squash, eggplant, corn, and the like and combinations thereof.

The following examples are illustrative of embodiments of the invention and are not intended to limit the invention as encompassed by the claims forming part of the application.

### EXAMPLE 1

An avocado of average size was peeled by placing the cut side down. The Avocado meat was scooped out from the fruit and placed in a meat grinder (Kitchen Aide®) having a grinder opening of about 1 cm in diameter. The avocado meat was mashed until it formed a uniform mashed product which was then removed from the meat grinder and placed in a container. The weight of the mashed avocado was determined and was used as a basis for determining the amount of the sulfated polysaccharide that was to be added to the mashed product as described below.

On a weight basis of 100%, the mashed avocado represented 98.88% of the total product. 0.12% by weight of iota carrageenan and 1.00% by weight of water (based on the total weight of the mashed product) was prepared in a separate container and mixed until a uniform aqueous mixture was obtained. Which took approximately three minutes. The uniform mixture containing the iota carrageenan was then blended in with the mashed avocado followed by mixing until a uniform product was obtained. The final product was refrigerated.

### EXAMPLE 2

A mashed food product was prepared in the same manner as Example 1, except that the sulfated polysaccharide (i.e. iota carrageenan) was omitted. The mashed food product produced herein was regarded as a control.

### EXAMPLE 3

The mashed food product of Example 1 and the control of Example 2 were tested for color using a Minolta Colorimeter Model CR-300 suitably employed for determining enzymatic browning of food products. The respective food products were tasted upon formation and on days 1, 2 and 7 to determine relative color over the course of 7 days.

Color measurements were made using standard (L*a*b*) hue and chroma charts. The Chromameter converts all colors within the range of human perception into a common numerical code to finally enable anyone to evaluate and examine a precise color. A relative high L value is indicative of a bright, fresh appearance while a relative low L value is indicative of dark, dull color generally regarded as unappealing when measuring the color of fruits and vegetables.

The “a” value is indicative of the intensity of the color green in the food product (i.e. a relatively high negative value for the “a” value is indicative of a high-intensity green color) as compared to a relatively high positive value for “a” which is indicative of an intense red color. A high negative “a” value is considered desirable for most fruits and vegetables.

The “b” value is indicative of the relative intensity of yellow (i.e. relatively high positive “b” value) and blue (relatively negative value of “b”). A high positive “b” value is considered desirable for most fruits and vegetables. The results of the comparative tests are shown in Table 1.

TABLE 1

| | Sample | Control |
|---|---|---|
| | INITIAL | INITIAL |
| pH | 6.64 | 6.63 |
| L | 64.17 | 65.91 |
| a | −15.29 | −15.23 |
| b | +35.95 | +36.53 |
| | Day 1 | Day 1 |
| L | 63.7 | 52.16 |
| a | −15.58 | −4.34 |
| b | 36.84 | 27.98 |
| | Day 2 | Day 2 |
| L | 60.41 | 45.88 |
| a | −14.74 | 0.83 |
| b | 35.76 | 21.25 |
| | Day 7 | Day 7 |
| L | 61.17 | 46.1 |
| a | −13.04 | −0.75 |
| b | 34.27 | 22.36 |

As shown in Table 1, the mashed food product treated with the sulfated polysaccharide in the absence of an acidulant maintained desirable L, a and b values during the seven day test. To the contrary, the control exhibited undesirable changes in L, a and b values even after one day.

The results show that at relatively low concentrations of sulfated polysaccharide (0.12% by weight) and in the absence of an acidulant a desirable anti-enzymatic browning effective was achieved.

What is claimed is:

1. A method of inhibiting enzymatic browning of pulp or mashed fruits and vegetables comprising:
combining a pulp form of the fruits and vegetables with at least one sulfated polysaccharide in an amount sufficient to inhibit enzymatic browning.

2. The method of claim 1 comprising conducting the method in the absence of the addition of an organic acid.

3. The method of claim 1 wherein the sulfated polysaccharide is selected from the group consisting of carrageenans, amylose sulfate, xylan sulfate and combinations thereof.

4. The method of claim 3 wherein the carrageenan is selected from the group consisting of iota carrageenan, lambda-carrageenan, kappa-carrageenan and combinations thereof.

5. The method of claim 3 wherein the at least one sulfated polysaccharide selected from the group consisting of iota carrageenan and lambda-carrageenan.

6. The method of claim 1 wherein the amount of the sulfated polysaccharide is from about 0.05 to 0.3% by weight based on the total weight of the pulp or mashed fruits and vegetables.

7. The method of claim 6 wherein the amount of the sulfated polysaccharide is less than about 0.25% by weight.

8. The method of claim 6 wherein the amount of the sulfated polysaccharide is less than about 0.20% by weight.

9. A pulp or mashed fruit or vegetable food product comprising:
a) at least one pulped or mashed fruit or vegetable; and
b) at least one sulfated polysaccharide in an amount sufficient to inhibit enzymatic browning.

10. The food product of claim 9 wherein the product has no added acid.

11. The food product of claim 9 wherein the sulfated polysaccharide is selected from the group consisting of carrageenans, amylase sulfate, xylan sulfate and combinations thereof.

12. The food product of claim 11 wherein the carrageenan is selected from the group consisting of iota carrageenan, lambda carrageenan, kappa carrageenan and combinations thereof.

13. The food product of claim 11 wherein the sulfated polysaccharide includes at least one carrageenan selected from the group consisting of iota carrageenan and lambda carrageenan.

14. The food product of claim 9 wherein the amount of the sulfated polysaccharide is from about 0.05 to 0.3% by weight based on the total weight of the product.

15. The food product of claim 14 wherein the amount of the sulfated polysaccharide is less than about 0.25% by weight.

16. The food product of claim 14 wherein the amount of the sulfated polysaccharide is less than about 0.20% by weight.
